(19) United States
(12) Patent Application Publication
(10) Pub. No.: US 2023/0121924 A1
(43) Pub. Date: Apr. 20, 2023

(54) PERFORMING LIFECYCLE MANAGEMENT

(71) Applicant: METASWITCH NETWORKS LTD, Enfield (GB)

(72) Inventor: Peter Louis WHITE, Redmond, WA (US)

(21) Appl. No.: 17/905,593

(22) PCT Filed: Mar. 3, 2021
(86) PCT No.: PCT/US21/20755

§ 371 Date: Sep. 2, 2022

(30) Foreign Application Priority Data
Mar. 4, 2020 (GB) 2003142.3

(51) Int. Cl. G06F 9/48; G06F 9/455

(52) U.S. Cl. CPC G06F 9/485; G06F 9/45533

(57) ABSTRACT

Lifecycle management is implemented in a data processing system. A first workload is provided in a first workload environment. The first workload is used to align one or more first lifecycle management states of the first workload in the first workload environment and one or more second lifecycle management states of a second workload. The second workload is in a second, different workload environment.

### TECHNICAL FIELD

The present disclosure relates to performing lifecycle management.

### BACKGROUND

Lifecycle management of workloads, such as Virtual Machines (VMs) and physical servers, is challenging. For example, there may be a need to create a number of VMs, detect when any fail, heal any failed VMs by deleting and recreating them, and/or scale the pool of VMs up or down dynamically. An orchestrator can be written for, and run in, the particular VM environment (such as OpenStack or VMware) in which the VMs are located. This can enable lifecycle management events to occur and lifecycle management actions to be performed. Such orchestrators can, however, be heavyweight, fragile, hard-to-use and/or heavily environment-specific.

### SUMMARY

According to first embodiments, there is provided a method of performing lifecycle management in a data processing system, the method comprising:

providing a first workload in a first workload environment; and

using the first workload to align one or more first lifecycle management states of the first workload in the first workload environment and one or more second lifecycle management states of a second workload,

wherein the second workload is in a second, different workload environment.

According to second embodiments, there is provided a data processing system arranged to perform a method according to the first embodiment.

According to third embodiments, there is provided a workload configured, when executed, to be used according to the first embodiment, wherein the workload is the first workload.

Further features and advantages will become apparent from the following description, given by way of example only, which is made with reference to the accompanying drawings.

### BRIEF DESCRIPTION OF THE DRAWINGS

FIG. 1 shows a schematic block diagram representing an example of a data processing system;

FIG. 2 shows a flowchart representing an example of a method of performing lifecycle management;

FIG. 3 shows a schematic block diagram representing another example of a data processing system;

FIG. 4 shows a schematic block diagram representing another example of a data processing system;

FIG. 5 shows a schematic block diagram representing another example of a data processing system;

FIG. 6 shows a schematic block diagram representing another example of a data processing system; and

FIG. 7 shows a schematic block diagram representing another example of a data processing system.

### DETAILED DESCRIPTION

Examples described herein relate generally to inter-environment (or “cross-environment”) lifecycle management in which lifecycle management functionality in one environment is leveraged in another environment. This differs from the above-described intra-environment lifecycle management where the lifecycle management functionality is within the same environment as the workload(s) being managed. For example, lifecycle management functionality in a containerized environment, such as Kubernetes, may be leveraged to perform inter-environment lifecycle management of VMs in a VM environment, such as OpenStack. As such, a heavyweight, fragile and/or hard-to-use, custom-written orchestrator for a VM environment may not be needed to manage VMs in the VM environment. Furthermore, in contrast to the above-described scenario in which many environment-specific orchestrators are written and each is specific to the particular environment in which it is used, in examples the need to write more than one such orchestrator may be avoided and existing orchestrator functionality may be used.

Inter-environment lifecycle management goes against a prejudice in the art that combining multiple different environments, such as Kubernetes and VMs (which are typically seen as separate technologies), would increase complexity. Inter-environment lifecycle management differs from multiple different environments merely interacting with each other, for example where a workload in one environment merely communicates with a workload in another environment. In contrast, inter-environment lifecycle management specifically involves cross-environment lifecycle management. The term “workload” is used in relation to Kubernetes to mean a container running as a component of an application running on Kubernetes, but should be understood more generally to additionally include other entities in relation to which lifecycle management can be performed, examples of which include, but are not limited to, VMs and physical servers.

Taking the above example of Kubernetes and a VM environment, existing VM functionality could, in principle, be migrated from VMs in the VM environment to containerized workloads in Kubernetes, such that Kubernetes manages the migrated-to containerized workloads in its own environment. However, in practice, such migration can involve significant resources (for example, time) and some such functionality may be required, or may be preferred, to be run in the VM environment such that it cannot, in practice, be migrated. As such, in practice, it may still be necessary to provide some functionality via VMs within a VM environment. For example, VM environments may be optimised for large processes with complicated logic and networking. Kubernetes, on the other hand, may be optimised for fast-fail, smaller processes and for less complicated networking needs. In particular, VMs can have multiple network interfaces that can map directly to physical interfaces, whereas containers normally each have one network interface that is mapped onto a small number of physical interfaces. Hence, VMs can have more flexible and capable networking in some environments.

In examples described herein, software instances (also referred to herein as “workloads”, “shadows” or “shadow workloads”) are created in a first environment (also referred to herein as a “platform”). Such software instances operate as shadow workloads of workloads in a second, different environment. The shadow workloads are therefore associated with the workloads in the second environment. Such association may be one-to-one in that a given shadow workload in the first environment is associated with a single, given workload in the second environment. The shadow workloads are managed in the first environment by a layer (referred to herein as a “deployment orchestration” layer) in the first environment. As such, the shadow workloads, which are in the first environment, are managed by a deployment orchestration layer in the same, first environment. Shadow workloads are used to align one or more first lifecycle management states of the shadow workload in the first environment and one or more second lifecycle management states of an associated workload in the second environment. Actions, in particular lifecycle management actions, taken on and affecting the lifecycle management state of the shadow workloads in the first environment are passed through to the workloads in the second environment such that the lifecycle management states of the workloads in the second environment are aligned with those of the shadow workloads in the first environment and/or vice versa. Outcomes of such actions are reported back via the shadow workloads, for example via the lifecycle management states of the shadow workloads.

As will be described in more detail below, the deployment orchestration layer in the first environment may create a shadow workload in the first environment, such that the shadow workload has a ‘created’ lifecycle management state related to creation of the shadow workload. The newly created shadow workload may, in turn, create an associated workload in the second environment. The newly created workload in the second environment then also has a ‘created’ lifecycle management state, which aligns with (or “matches”, “maps to”, or “mirrors”) the ‘created’ lifecycle management state of the shadow workload. In addition, in response to the shadow workload determining that the workload in the second environment has a ‘ready’ lifecycle management state corresponding to readiness of the workload in the second environment (for example where the workload in the second environment has the correct configuration and is healthy), the shadow workload may align its lifecycle management state with that of the workload in the second environment, namely the ‘ready’ lifecycle management state. The shadow workload can then report its ‘ready’ lifecycle management state to the deployment orchestration layer in the first environment.

By managing the shadow workloads in the first environment, the deployment orchestration layer of the first environment is therefore leveraged in the second environment.

In examples, the first and second environments use different technologies, such as container and VM technology respectively. If, in contrast, the first and second environments used the same technology as each other, the deployment orchestration layer in the first environment could simply also be run in the second environment. The techniques described herein are therefore more effective for cross-environment lifecycle management, where the different environments use different technologies.

Examples described herein allow existing deployment orchestration layer technologies, such as Kubernetes, to be leveraged in an environment-neutral way. Such existing deployment orchestration layer technology, for example Kubernetes, may be robust, well-maintained and well-tested. Such existing technology may be leveraged, as opposed to writing a custom lifecycle manager (LCM) product or using another, less capable product. In examples, existing capability of existing software is used in one environment, such as Kubernetes, to manage workloads in another environment, for example VMs. In particular, Kubernetes operates a deployment orchestration layer to provide Application Programming Interfaces (APIs) and functions to manage containers, including the lifecycle management code described herein. Having a single Kubernetes cluster manage a set of VMs (outside the Kubernetes environment) allows consistent management in a single location, where the control over all of the workloads (containers, VMs, physical bare metal servers etc.) is managed in one location with consistent APIs and even the same code. Kubernetes comes with a range of capabilities to add features such as role-based access control (RBAC), audit, GitOps integration etc. Such functionality therefore comes by default by using Kubernetes. If using a custom-written orchestrator instead, the orchestrator itself would need to be managed; healing the orchestrator when it fails, making the orchestrator high-availability (HA) etc. Kubernetes is self-healing and can be readily deployed in HA mode, unlike most orchestration products.

In examples, the logic used to manage VMs is split into two parts; the complex lifecycle logic is performed in Kubernetes independently of the underlying platform, and the platform specific logic is maintained in container images. The container images are, however, designed to be lightweight and small in size (compared, for example, to the size of VMs), and the techniques described herein can readily be applied to various platforms, for example OpenStack, VMware, cloud platforms such as Azure and Amazon Web Services (AWS), and even bare metal. In examples, the container images can be made small (and useable across applications and, to some extent, VM environments) because they do not have orchestration or application logic. Instead, in examples, they have minimal logic, namely to check that a workload (for example, a VM) with certain parameters exists.

In addition to facilitating lifecycle management of workloads in one environment by leveraging a deployment orchestration layer in another environment, examples described herein also facilitate external reporting. For example, Kubernetes can provide one dashboard showing the state of all the workloads it manages (whether containers, VMs, or physical servers).

In examples described herein, an orchestrator exists in a first environment (for example a Kubernetes environment). The orchestrator is responsible for managing a collection of one or more software instances in the first environment. Some or all of the one or more software instances map, one-to-one, to one or more separate software instances in a second, different environment (for example VMs in a VM environment). Lifecycle actions received from the orchestrator in the first environment, affecting the mapped software instances, are passed along to the second, paired environment, in a manner that the second environment understands, for example by first-to-second-environment mapping. Responses and state from the second environment are passed back so that each of the one-to-one-mapped software instances in the second environment appears correctly to the orchestrator in the first environment, for example by second-to-first-environment mapping.

A known project, vmctl, used Kubernetes to manage VMs through a shadow-config model. However, vmctl managed VMs inside Kubernetes resources, instead of managing VMs outside Kubernetes. The vmctl project was, therefore, far more limited than the techniques described herein because vmctl only managed VMs in a very limited environment where the VMs were created inside containers inside the Kubernetes environment. In contrast, the techniques described herein enable infrastructure outside of a Kubernetes environment to be managed from within the Kubernetes environment.

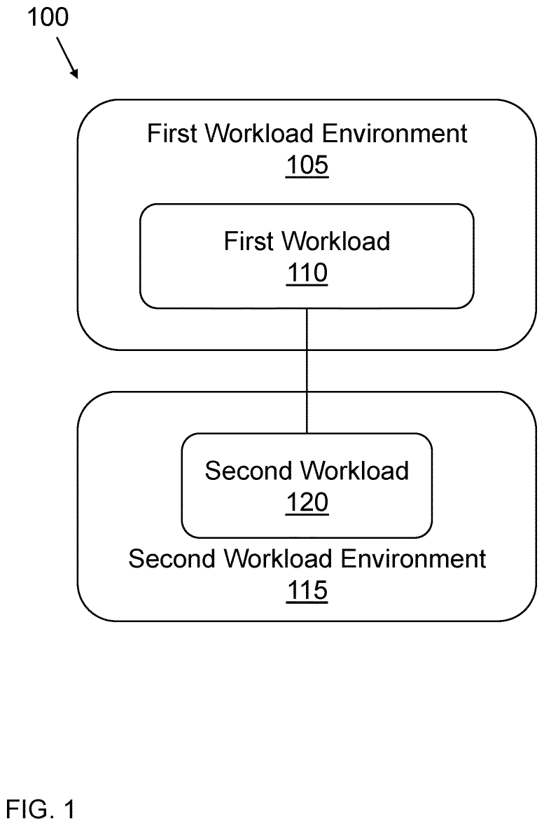

Referring to FIG. 1, there is shown an example of a data processing system 100.

The data processing system 100 comprises a first environment 105, which in this example is a workload environment. The term “workload environment” is used herein to mean an environment in which a workload can be located. In this example, the first environment 105 is a containerized environment, of which Kubernetes is an example. The first environment 105 comprises a first workload 110 which, in this example, is a containerized workload. In this example, the first workload 110 is a shadow workload.

The data processing system 100 comprises a second environment 115, which is different from the first environment 105 in that the first and second environments 105, 115 use different technologies. The second environment 115 comprises a second workload 120, which could, for example, be a VM or a physical server. In this example, the second workload 120 provides telephony functionality, such as Voice over Long-Term Evolution (VoLTE) functionality, Media Resource Function (MRF) functionality, IP Multimedia Subsystem (IMS) core functionality, Session Border Controller (SBC) functionality, etc. This functionality may need to be, or may be more efficiently, performed by VMs rather than containers, for example because of complexity, networking requirements, cost of reimplemented existing virtualized code, etc.

In this example, the shadow workload 110 does not provide telephony functionality, and its sole, or primary, function is to serve as a shadow workload, performing lifecycle management of the second workload 120 (also referred to herein as “lifecycle-managing” or “owning” the second workload 120).

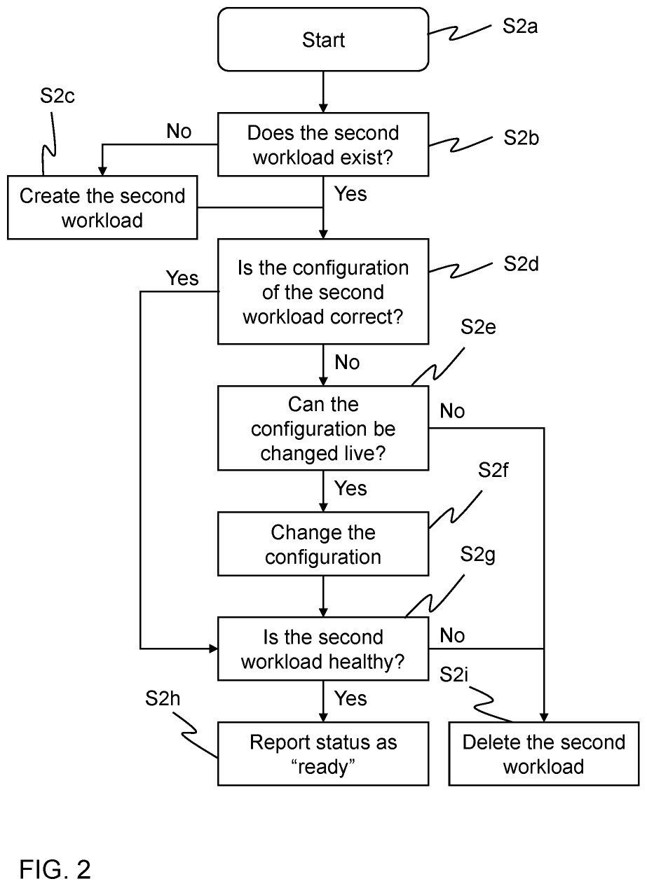

Referring to FIG. 2, there is shown an example method of performing lifecycle management in relation to a workload. In this example, the method is performed in the data processing system 100 shown in FIG. 1.

In this example method, the shadow workload 110 is used to align one or more first lifecycle management states of the shadow workload 110 and one or more second lifecycle management states of the second workload 120.

At item, S2a, the shadow workload 110 starts a lifecycle management routine. The shadow workload 110 may perform the routine intermittently. The routine may be performed periodically, such as every 30 seconds. In this example, the routine involves checking whether the second workload 120 exists and, if so, whether the second workload 120 has the correct image and/or configuration and is healthy.

At item S2b, the shadow workload 110 checks whether the second workload 120 exists.

If the second workload 120 does not already exist, then the shadow workload 110 creates the second workload 120 at item S2c. To create the second workload 120, the shadow workload 110 may generate a ‘create’ command and transmit the ‘create’ command to the second environment 115. Such transmitting may comprise the shadow workload 110 making an API call to the second environment 115, for example over a Hypertext Transfer Protocol Secure (HTTPS) interface between the first and second environments 105, 115.

At item S2d, the shadow workload 110 checks whether the second workload 120 has the correct configuration.

As item S2e, if the second workload 120 exists but has the wrong configuration, the shadow workload 110 determines whether the configuration can be changed live.

At item S2f, if the configuration can be changed live, then the shadow workload 110 changes the configuration of the second workload 120.

At item S2g, the shadow workload 110 checks whether the second workload 120 is healthy.

At item S2h, if the second workload 120 has the correct configuration and is healthy, the second workload 120 is deemed to be in the ‘ready’ lifecycle management state. The shadow workload 110 aligns its own lifecycle management state with the ‘ready’ lifecycle management state of the second workload 120. In this example, this involves the shadow workload 110 reporting its lifecycle management state as “ready” to the deployment orchestration layer in the first environment 105. As such, the shadow workload 110 reports a status of “ready” if the second workload 120 is up and ready with the correct configuration.

At item S2i, if the second workload 120 exists but has the wrong configuration which cannot be changed live or if the second workload 120 exists but is unhealthy, the shadow workload 110 deletes the second workload 120. A later cycle of the routine can (re)create the second workload 120.

The shadow workload 110 may transmit an authentication token to the second environment 115 one or more times during and/or outside the routine. The authentication token indicates that the shadow workload 110 can lifecycle-manage (for example, create) the second workload 120. The authentication token may be a secret stored by the shadow workload 110 following authentication of credentials (such as a username and password) provided by the shadow workload 110 to the second environment 115.

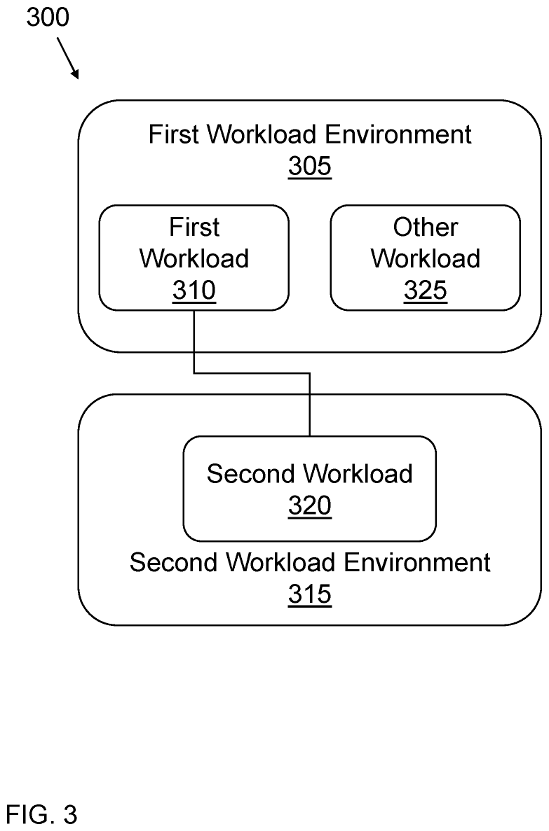

Referring to FIG. 3, there is shown another example of a data processing system 300. The example data processing system 300 shown in FIG. 3 includes several elements which are the same as, or are similar to, corresponding elements shown in FIG. 1. Such elements are indicated using the same reference sign, but incremented by 200.

In this example, the second workload 320 in the second environment 315 provides telephony functionality and has a shadow workload 310 in the first environment 305. In this example, the first environment 305 comprises another workload 325, which is not a shadow workload but is a “full-function” workload. In this example, the other workload 325 provides functionality that, when combined with the functionality provided by the second workload 320, allows the data processing system 300 to deliver a service (such as telephony). As such, the first environment 305 implements a mixed deployment of both a shadow workload 310 and a non-shadow, full-function workload 325, both of which coexist in, and can be managed by a common deployment orchestration layer in, the first environment 305.

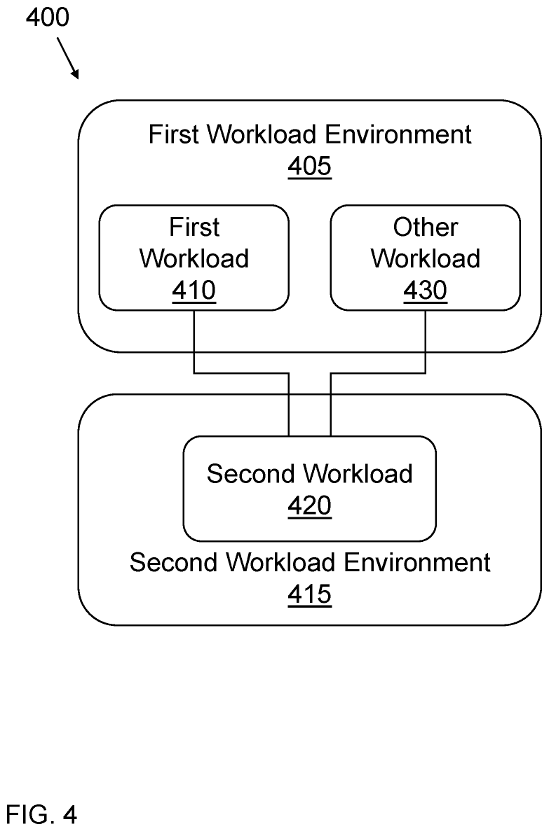

Referring to FIG. 4, there is shown another example of a data processing system 400. The example data processing system 400 shown in FIG. 4 includes several elements which are the same as, or are similar to, corresponding elements shown in FIG. 3. Such elements are indicated using the same reference sign, but incremented by 100.

In this example, and similar to the example data processing system 300 shown in FIG. 3, the first environment 405 comprises another workload 430, in addition to the shadow workload 410. However, whereas in the example data processing system 300, the other workload 325 is a non-shadow, full-function workload providing telephony functionality, the other workload 430 in this example does not provide telephony functionality and is a shadow workload of the second workload 420. As such, in this example, both shadow workloads 410, 430 in the first environment 405 lifecycle-manage the second workload 420. One of the workloads 410, 430 in the first environment 405 may perform a lifecycle management action in relation to the second workload 420 that the other is not configured to perform. An example of such a lifecycle management action is to cause the second workload 420 to be deleted in response to a deletion condition being met, such as the first shadow workload 410 no longer being used to lifecycle-manage the second workload 420.

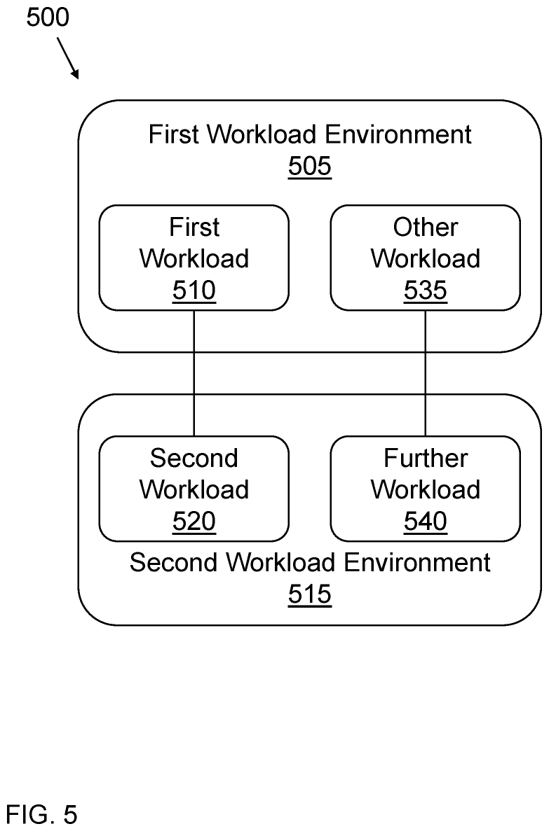

Referring to FIG. 5, there is shown another example of a data processing system 500. The example data processing system 500 shown in FIG. 5 includes several elements which are the same as, or are similar to, corresponding elements shown in FIG. 4. Such elements are indicated using the same reference sign, but incremented by 100.

In this example, and similar to the example data processing system 400 shown in FIG. 4, the first environment 505 comprises a first and another shadow workload 510, 535. However, whereas in the example data processing system 400, the other shadow workload 430 lifecycle-manages the second workload 430, the other shadow workload 535 in this example lifecycle-manages a further workload 540 which, in this example, is in the second environment 515. The workloads 520, 540 in the second environment 515 may have the same functionality as each other, or may have different functionalities. As such, in this example, there is a one-to-one mapping between the shadow workloads 510, 535 in the first environment 505 and corresponding workloads 520, 540 in the second environment 515, in that the workloads 510, 535 in the first environment 505 do not lifecycle-manage any workloads other than their respective, corresponding workloads 520, 540 in the second environment 515.

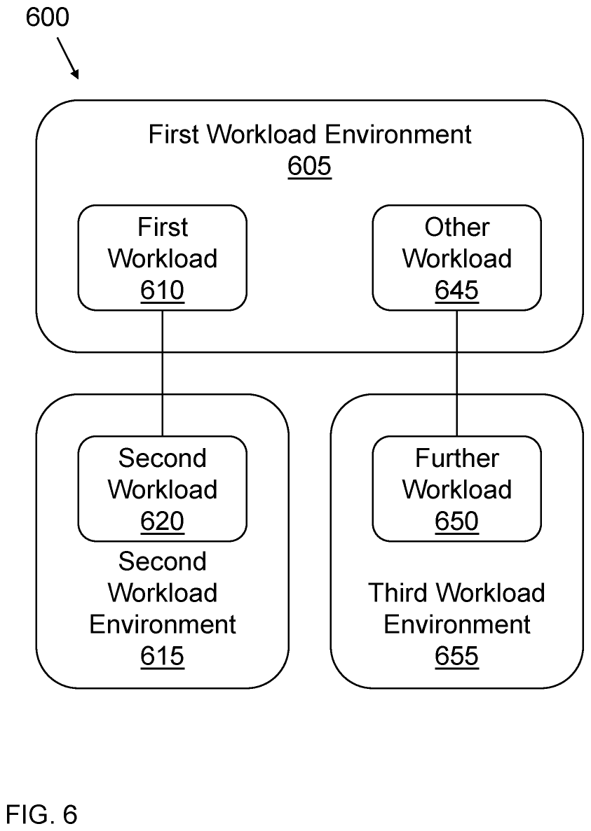

Referring to FIG. 6, there is shown another example of a data processing system 600. The example data processing system 600 shown in FIG. 6 includes several elements which are the same as, or are similar to, corresponding elements shown in FIG. 5. Such elements are indicated using the same reference sign, but incremented by 100.

In this example, and similar to the example data processing system 500 shown in FIG. 5, the first environment 605 comprises a first and another shadow workload 610, 645. However, whereas in the example data processing system 500, the other shadow workload 535 lifecycle-manages a further workload 540 in the second environment 515, the other shadow workload 645 in this example lifecycle-manages a further workload 650 in a third environment 655 which, in this example, is different from the first and second environments 605, 615. As such, in this example, workloads in multiple environments 615, 655 outside the first environment 605 are managed by the deployment orchestration layer in the first environment 605. This contrasts with an implementation in which environment-specific orchestrators are written for each of the second and third environments 615, 655. Even if some code were common to both such environment-specific orchestrators, a significant amount of environment-specific code would still be used for each environment.

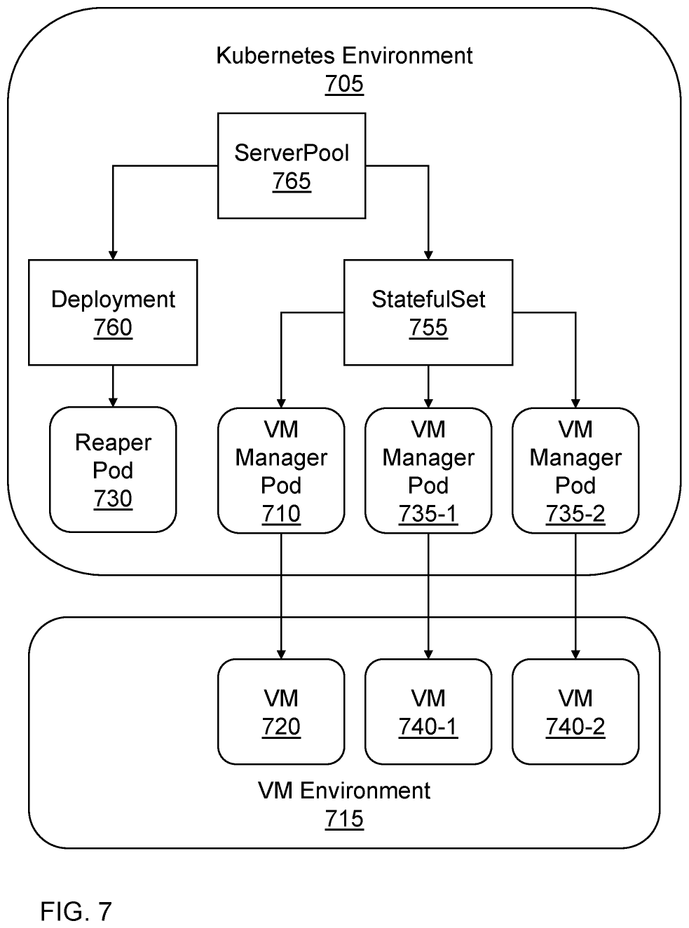

Referring to FIG. 7, there is shown another example of a data processing system 700. The example data processing system 700 shown in FIG. 7 includes several elements which are the same as, or are similar to, corresponding elements shown in one or more earlier Figures. Such elements are indicated using the same reference sign, but incremented by a multiple of 100.

The example data processing system 700 enables inter-environment lifecycle management in a specific example in which workloads in the form of VMs 720, 740-1, 740-2 in a VM environment 715 are managed by Kubernetes in a Kubernetes environment 705 via shadow workloads 710, 735-1, 735-2 in the Kubernetes environment 705.

In this example, the Kubernetes environment 705 comprises three entities 710, 735-1, 735-2, each of which is labelled “VM Manager Pod” in FIG. 7. Each entity 710, 735-1, 735-2 denotes a Kubernetes Pod comprising a single container, in turn comprising a single containerized workload. References herein to shadow workloads 710, 735-1, 735-2 should be understood, based on the context, to include references to the Pod itself, the container and/or the containerized workload as appropriate. In particular, the terms “Pod” and “container” may be used almost interchangeably since a Pod is a set of one or more containers sharing a network namespace managed as a unit.

Kubernetes understands containers but not VMs. As such, Kubernetes does not manage the VMs 720, 740-1, 740-2 directly, but manages the VMs 720, 740-1, 740-2 via the shadow workloads 710, 735-1, 735-2. In particular, Kubernetes performs lifecycle actions on the shadow workloads 710, 735-1, 735-2, which are mapped for and propagate to the VMs 720, 740-1, 740-2. The deployment orchestration layer in Kubernetes may be unaware that it is indirectly managing the VMs 720, 740-1, 740-2 through the shadow workloads 710, 735-1, 735-2, and even that the VMs exist 720, 740-1, 740-2.

To enable Kubernetes to manage the VMs 720, 740-1, 740-2 indirectly in this manner, a StatefulSet object 755 is created to manage the shadow workloads 710, 735-1, 735-2. StatefulSet objects 755 are used in Kubernetes to manage stateful workloads. A Deployment object 760 is also created to manage a separate shadow workload 730, which will be described in more detail below. Deployment objects 760 are used in Kubernetes to manage stateless workloads. Deployment objects 760 are typically more lightweight than StatefulSet objects 755 and may preferentially be used over StatefulSet objects 755 for stateless workloads. In this example in which the separate shadow workload 730 is implemented as a stateless workload, use of the Deployment object 760 can therefore provide an efficiency.

Manual configuration of the StatefulSet and Deployment objects 755, 760 could be relatively time-consuming and burdensome. In examples, the Kubernetes Operator model is used to facilitate such configuration. In this example, this corresponds to adding a new ServerPool object 765, and code in Kubernetes that creates any other objects for the pool. Within the example Kubernetes environment 705 shown in FIG. 7, the ServerPool object 765 is a new object defined by the present disclosure. StatefulSet and Deployment objects 755, 760 are standard objects with their own controllers and come with Kubernetes by default. The new ServerPool object 765 can be added using Kubernetes APIs, which can be extended to add new objects and controllers.

Kubernetes manages creating, rolling upgrades, healing, scaling, deleting, etc. of the shadow workloads 710, 735-1, 735-2. In this example, each shadow workload 710, 735-1, 735-2 is responsible for lifecycle-managing a single, respective VM 720, 740-1, 740-2 in a one-to-one correspondence, and is designed to use minimal logic.

As explained above, the shadow workload logic may simply be to know which VM 720, 740-1, 740-2 that shadow workload 710, 735-1, 735-2 lifecycle-manages, to delete the VM 720, 740-1, 740-2 if it is in the wrong state, to create the VM 720, 740-1, 740-2 if it does not exist, and/or to report the state of the VM 720, 740-1, 740-2 as “ready” if it exists in the correct state. The shadow workload 710, 735-1, 735-2 can recognise the VM 720, 740-1, 740-2 it lifecycle-manages using a VM identifier for that VM 720, 740-1, 740-2. Each shadow workload 710, 735-1, 735-2 is also responsible for taking information about its respective VM 720, 740-1, 740-2 and exposing that information to Kubernetes and/or applications running in the Kubemetes environment 705. For example, the shadow workloads 710, 735-1, 735-2 can report the version of their respective VM 720, 740-1, 740-2 and/or can report “ready” once their respective VM 720, 740-1, 740-2 is ready.

If a shadow workload 710, 735-1, 735-2 is created when the VM 720, 740-1, 740-2 it lifecycle-manages already exists and the VM 720, 740-1, 740-2 is already in the correct state (for example where Kubemetes detects failure of the shadow workload 710, 735-1, 735-2 and recreates the shadow workload 710, 735-1, 735-2), the shadow workload 710, 735-1, 735-2 may do nothing.

Deletion or failure of a shadow workload 710, 735-1, 735-2 could, in some situations, result in deletion of its respective VM 720, 740-1, 740-2. Cluster failure, in other words failure of all shadow workloads 710, 735-1, 735-2, could therefore lead to loss of all VMs 720, 740-1, 740-2.

In this example, VMs are not deleted by the shadow workloads 710, 735-1, 735-2 in the StatefulSet object 755. Instead, deletions are performed by the separate shadow workload 730 in the Deployment object 760, which is indicated by the label “Reaper Pod” in FIG. 7 and is referred to herein as the “reaper shadow workload”. The logic of the reaper shadow workload 730 can also be designed to have limited complexity, namely to find any managed VMs 720, 740-1, 740-2 that should not exist and remove them, for example by determining what the state of the VMs 720, 740-1, 740-2 should be from the ServerPool object 765. The reaper shadow workload 730 is particularly effective in Kubernetes, which is a fast-fail environment where shadow workloads 710, 735-1, 735-2 are expected to fail but can be spun up again quickly following failure. The reaper shadow workload 730 may also be effective where the cluster fails, restarts, and creates another set of VMs (not shown) corresponding to the restarted shadow workloads 710, 735-1, 735-2, by deleting the existing, now-unused, VMs 720, 740-1, 740-2. In examples, when the ServerPool object 765 is deleted, Kubernetes gives the reaper shadow workload 730 time to delete all the VMs 720, 740-1, 740-2.

As such, in this example, there is a single object, namely the ServerPool object 765, which has declarative configuration in the Kubernetes environment 705. When the ServerPool object 765 is created, an entire pool of VMs 720, 740-1, 740-2 is created and kept up-to-date. Changes to the configuration of the ServerPool object 765 are reflected in the VMs 720, 740-1, 740-2 automatically, for example by scaling and/or rolling update.

As explained above, an example lifecycle management event is a creation event. The shadow workloads 710, 735-1, 735-2 can be created one-by-one such that they each have a ‘created’ lifecycle management state. The ‘created’ lifecycle management states are to be mirrored in the VM environment 715 in that the creation of the shadow workloads 710, 735-1, 735-2 maps to the VMs 720, 740-1, 740-2 being created one-by-one by their respective shadow workloads 710, 735-1, 735-2. Following their creation, the VMs 720, 740-1, 740-2 are also in the ‘created’ lifecycle management state.

Another example lifecycle management event is a scale-out. In this example, extra shadow workloads can be added, leading to extra VMs just as for creation.

Another example lifecycle management event is a scale-in or delete event, in which shadow workloads are removed. In this example, the reaper shadow workload 730 is responsible for deleting VMs 720, 740-1, 740-2, since a shadow workload 710, 735-1, 735-2 cannot readily determine whether it is being shut down because the VMs 720, 740-1, 740-2 should be deleted, or because, for example, shadow workloads are being assigned a higher memory threshold or a node error case has occurred. Scale-in may be considered to have two parts. Firstly, the shadow workloads 710, 735-1, 735-2 are removed as the StatefulSet object 755 is reconfigured. Secondly, the reaper shadow workload 730 removes the VMs 720, 740-1, 740-2 as the reaper shadow workload 730 is reconfigured. The keeping of the configuration and the StatefulSet object 755 consistent is a reason for the provision of the ServerPool object 765 and operator.

Another example lifecycle event is a healing event. In this example, a failed shadow workload 710, 735-1, 735-2 is replaced by Kubernetes, and a failed VM 720, 740-1, 740-2 is detected and replaced by its shadow workload 710, 735-1, 735-2.

Another example lifecycle management event is an upgrade or modify event. In this example, the shadow workloads 710, 735-1, 735-2 can be replaced one-by-one, so they are consecutively shut down and recreated with updated configuration. Kubernetes has the intelligence to perform the replacement only when previous shadow applications are reporting “ready”; in other words when they have done whatever is necessary to their mapped workloads. This rolling upgrade or replacement is a default Kubernetes feature that does not exist in OpenStack (for example) by default. Only a single VM environment 715, a single ServerPool object 765, and three VMs 720, 740-1, 740-2 are shown in FIG. 7. However, there could be different numbers of any of these elements in other examples. Arrows in FIG. 7 show control and ownership. Control within Kubernetes means that a controller running in Kubernetes manages lower-level objects based on declarative configuration of higher-level objects, including creating, deleting, scaling, rolling upgrade etc. as applicable.

In examples, all of the shadow workloads 710, 735-1, 735-2 in the StatefulSet object 755 have the same specification as each other, although the shadow workloads 710, 735-1, 735-2 are parameterized such that, for example, the third shadow workload 735-2 can determine that it is the third shadow workload 735-2.

Different applications may be migrated one-by-one, for example from the VM environment 715 to the Kubernetes environment 705, with such migration being performed at the application level. For example, three different applications, each having a number of VMs, may have three corresponding ServerPool setups in the Kubernetes environment 705 to manage them. One application could be migrated to Kubernetes by removing the entire ServerPool setup corresponding to that application and replacing that ServerPool setup with native objects running in the Kubemetes environment 705, with Kubernetes managing the workloads throughout the migration process.

The above embodiments are to be understood as illustrative examples. Further embodiments are envisaged.

In examples described above, the managed workload is a VM. The techniques described herein may, however, be extended to managing other types of workload. For example, the techniques described herein may be applied to other cloud technologies and/or to physical servers. For physical servers, the shadow workload might not be able to delete or create a physical server, but may validate that the physical server exists, may restart the physical server if it is unhealthy, may perform rolling state changes using another method (such as ansible scripting), and/or may make use of an automated physical server deployment platform, for example “metal as a service”.

Examples described above relate to container-based lifecycle management of VMs. The techniques described herein may extend to container-based lifecycle management of any slower, larger technology, or even lifecycle management of one technology by another technology if there is a reason to leverage such lifecycle management.

GitOps and/or continuous integration/continuous delivery (Cl/CD) integration may be added using the declarative configuration in the new ServerPool object to make rollout of state to the deployment orchestration layer automatic.

Similar techniques to those described herein could be used to replicate containers in one environment, in another container environment. However, as explained above, this may not be as effective as cross-environment lifecycle management.

Different balances between the intelligence and logical complexity of the shadow workloads against the framework around them to facilitate this could be provided. For instance, the shadow workloads could implement the required logic to translate commands and information internally or could utilize services offered in either (or both) environments to perform such translation.

In examples described above, the shadow workloads map one-to-one with other workloads. This enables the shadow workloads to be designed to be relatively simple in terms of logic. The shadow workloads could have a one-to-many mapping, but this may move the orchestration challenge to the shadow workloads, increasing complexity and decreasing granularity with little, if any, benefit especially where shadow workloads are relatively easy to spin up. One shadow workload could potentially manage an active-standby pair of workloads, but again additional logic may be needed in the shadow workloads to report failure of one but not the other of the workloads to avoid a shared-fate scenario.

Examples described above relate primarily to Kubernetes. In other examples, alternative containerized environments, such as Docker Swarm and Mesos, could be used.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed:

1. A method of performing lifecycle management in a data processing system, the method comprising:
instantiating a first workload in a first workload environment executing in the data processing system; and
using the first workload to align a first lifecycle management state of the first workload in the first workload environment and a second lifecycle management state of a second workload,
wherein the second workload is instantiated in a second, different workload environment executing in the data processing system.

2. The method according to claim 1, wherein the first workload environment is a Kubernetes environment.

3. The method according to claim 1, wherein the first workload performs lifecycle management of only the second workload.

4. The method according to claim 1, wherein the second workload is a virtual machine.

5. The method according to claim 1, wherein the second workload is configured to provide telephony functionality and the first workload is configured to provide a different functionality.

6. The method according to claim 1, wherein the first workload environment comprises another workload configured to provide telephony functionality.

7. The method according to claim 6, wherein the other workload is configured to perform lifecycle management in relation to the second workload.

8. The method according to claim 7, wherein the lifecycle management performed by the other workload comprises causing the second workload to be deleted in response to a deletion condition comprising the first workload no longer being used to perform lifecycle management in relation to the second workload.

9. The method according to claim 8, wherein the other workload is configured to perform lifecycle management in relation to a further workload that is in the second workload environment.

10. The method according to claim 9, wherein the further workload is in a third workload environment, the third workload environment being different from the first and second workload environments.

11. The method according to claim 1, further comprising using the first workload to transmit an authentication token to the second workload environment.

12. The method according to claim 1, further comprising using the first workload to provide status report data in relation to the second workload.

13. The method according to claim 1, wherein the second lifecycle management state relate to one of:
creating the second workload; or
readiness of the second workload.

14. A data processing system comprising a processor and memory storing computer-executable instructions that, when executed by the processor, cause the data processing system to perform operations comprising:
instantiating a first workload in a first workload environment executing in the data processing system; and
using the first workload to align a first lifecycle management state of the first workload in the first workload environment and a second lifecycle management state of a second workload,
wherein the second workload is instantiated in a second, different workload environment executing in the data processing system.

15. (canceled)

16. The data processing system according to claim 14, wherein the first workload environment is a containerized environment.

17. The data processing system according to claim 14, wherein the second workload is configured to provide telephony functionality.

18. The data processing system according to claim 14, wherein:
the first workload environment comprises another workload configured to provide telephony functionality and the other workload is not configured to perform lifecycle management.

19. The data processing system according to claim 14, wherein:
the first workload environment comprises another workload configured to perform lifecycle management in relation to the second workload.

20. The data processing system according to claim 19, wherein:
the other workload is configured to perform lifecycle management in relation to a further workload in the second workload environment.

21. A computer-readable storage medium having computer-executable instructions stored thereupon which, when executed by one or more processors of a computing device of a data processing system, cause the computing device to:
instantiate a first workload in a first workload environment executing in the data processing system; and
use the first workload to align a first lifecycle management state of the first workload in the first workload environment and a second lifecycle management state of a second workload,
wherein the second workload is instantiated in a second, different workload environment executing in the data processing system.
